(19) United States
(12) Patent Application Publication
(10) Pub. No.: US 2024/0229845 A9
(43) Pub. Date: Jul. 11, 2024

(54) Device and Method of Use for Magnetic Panel Joint

(71) Applicant: Neil Deshpande, Atlanta, GA (US)

(72) Inventor: Neil Deshpande, Atlanta, GA (US)

(21) Appl. No.: 18/235,495

(22) Filed: Aug. 18, 2023

Related U.S. Application Data
(60) Provisional application No. 63/418,471, filed on Oct. 21, 2022.

(51) Int. Cl. F16B 12/28

(52) U.S. Cl. CPC F16B 12/28; F16B 2200/83

(57) ABSTRACT

Disclosed herein are systems for a magnetic panel joint and magnetically joined, paneled storage units. The magnetic panel joint comprises a first magnetic panel including an angled protrusion defining a first receptacle, a second magnetic panel including a groove body defining a groove and a second receptacle, and a magnetic fastener. The angled protrusion can be removably inserted into the groove to enable alignment of the first receptacle and the second receptacle, and the magnetic fastener can be removably inserted into the aligned receptacles to enable secure coupling of the first magnetic panel and the second magnetic panel. The second magnetic panel may include a slot body defining a slot and a receptacle. An angled protrusion of a third panel can be removably inserted into the slot. Each individual panel may be a horizontal shelf, a vertical wall, or a rear wall or a storage unit.

### TECHNICAL FIELD

The present disclosure generally relates to joinery and, more particularly, magnetic panel joints. Magnetic panel joints enable quick assembly of magnetic panels for use in a variety of fields including shelving, cabinetry, and storage solutions. Furthermore, magnetic panel joints allow paneled structures to be easily expanded vertically or horizontally. The disclosed invention also enables a secure and aesthetically pleasing joint.

### BACKGROUND

The present disclosure relates in general to a magnetic panel joint, and more specifically, to removably connected magnetic panels.

It is known in the prior art that there are paneled structures for use in shelving, cabinetry, and storage solutions. These paneled structures differ in construction and assembly methods. Many paneled structures have multiple panels joined by hardware such as brackets, pins, rods, screws, and bolts. Consumers must assemble these paneled structures using tools. These paneled structures are also difficult to disassemble. Many paneled structures, once assembled, are insecure and unsafe.

The present disclosure differs from the above referenced disclosures and others that are similar in that the present disclosure allows for faster, tool-free, assembly and disassembly, and enables a secure and safe paneled structure.

### SUMMARY

Embodiments of the disclosure provide a magnetic panel joint and magnetically joined, paneled storage units. The magnetic panel joint comprises a first magnetic panel including an angled protrusion defining a first receptacle, a second magnetic panel including a groove body defining a groove and a second receptacle, and a magnetic fastener. The angled protrusion can be removably inserted into the groove to enable alignment of the first receptacle and the second receptacle, and the magnetic fastener can be removably inserted into the aligned receptacles to enable secure coupling of the first magnetic panel and the second magnetic panel.

According to some embodiments, the second magnetic panel may include a slot body defining a slot and a receptacle. An angled protrusion of a third panel can be removably inserted into the slot. Each individual panel may be a horizontal shelf, a vertical wall, or a rear wall or a storage unit.

It is to be understood that both the foregoing general description and the following detailed description are exemplary and explanatory only and are not restrictive of the disclosed embodiments.

### BRIEF DESCRIPTION OF THE FIGURES

The accompanying drawings, which are incorporated in and constitute a part of this specification, illustrate several embodiments and, together with the description, serve to explain the disclosed principles. In the drawings:

FIG. 1A is an exploded view of a magnetic panel joint in accordance with some embodiments of the present disclosure;

FIG. 1B is an exploded view of a magnetic panel joint displaying a vertical side wall and a horizontal shelf;

FIG. 2A is a perspective view of an assembled magnetic panel joint in accordance with some embodiments of the present disclosure;

FIG. 2B is a perspective view of an assembled magnetic panel joint displaying a vertical side wall panel and a horizontal shelf panel;

FIG. 3A is a bottom view of a horizontal shelf panel displaying external receptacles, a slot body, and a slot;

FIG. 3B is a perspective view of a horizontal shelf panel displaying external receptacles, a groove body, and groove;

FIG. 4 is a is a perspective view of a horizontal shelf panel in accordance with some embodiments of the present disclosure;

FIG. 5 is a perspective view of an external vertical shelf wall in accordance with some embodiments of the present disclosure;

FIG. 6A is a perspective view of an internal vertical shelf wall in accordance with some embodiments of the present disclosure;

FIG. 6B is a is a perspective view of an internal vertical shelf wall in accordance with some embodiments of the present disclosure;

FIG. 7A is a top view of a magnetic fastener in accordance with some embodiments of the present disclosure;

FIG. 7B is a perspective view of a magnetic fastener in accordance with some embodiments of the present disclosure;

FIG. 8A is an exploded view of a magnetic panel joint displaying a vertical rear wall and a horizontal shelf;

FIG. 8B is an exploded view of a magnetic panel joint in accordance with some embodiments of the present disclosure;

FIG. 9A is a perspective view of an assembled magnetic panel joint in accordance with some embodiments of the present disclosure;

FIG. 9B is a perspective view of an assembled magnetic panel joint displaying a vertical rear wall panel and a horizontal shelf panel;

FIG. 10 is a perspective view of a rear wall panel;

FIG. 11 is an exploded view of a shelf assembly displaying a foot component and a tee component;

FIG. 12A is a perspective view of a shelf assembly displaying a foot component and a tee component;

FIG. 12B is a perspective view of a shelf assembly displaying a foot component and a tee component;

FIG. 13 is a perspective view of a foot component displaying a foot and a protrusion;

FIG. 14 is a perspective view of a tee component displaying a foot component and multiple protrusions;

FIG. 15 is a perspective view of a partially assembled one by two shelf assembly in accordance with some embodiments of the present disclosure;

FIG. 16 is a perspective view of an assembled one by two shelf assembly in accordance with some embodiments of the present disclosure;

FIG. 17 is an exploded view of multiple magnetic panel joints in accordance with some embodiments of the present disclosure;

FIG. 18A is an exploded view of multiple magnetic panel joints in accordance with some embodiments of the present disclosure;

FIG. 18B is an exploded view of multiple magnetic panel joints in accordance with some embodiments of the present disclosure;

FIG. 19 is a top view of stacked protrusions;

FIG. 20 is a perspective view of a two by two shelf assembly in accordance with some embodiments of the present disclosure;

FIG. 21 is a perspective view of a two by two shelf assembly in accordance with some embodiments of the present disclosure;

FIG. 22A is a perspective view of a double panel displaying protrusions in accordance with some embodiments of the present disclosure;

FIG. 22B is a perspective view of a double panel displaying cabinet hardware fastener receptacles in accordance with some embodiments of the present disclosure;

FIG. 23A is a perspective view of a double panel assembly displaying a double panel;

FIG. 23B is a perspective view of a double panel assembly displaying an external vertical shelf wall

FIG. 24 is a perspective view of a double panel assembly displaying cabinet hardware components and a door;

FIG. 25 is a flow diagram of a method of joining two magnetic panels.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims. The terms and definitions provided herein control, if in conflict with terms or definitions incorporated by reference.

The present invention relates to magnetic panel joints including for example, magnetic shelf panel joints comprising a magnetic panel including a protrusion, a magnetic panel defining a groove or slot, and a magnetic fastener.

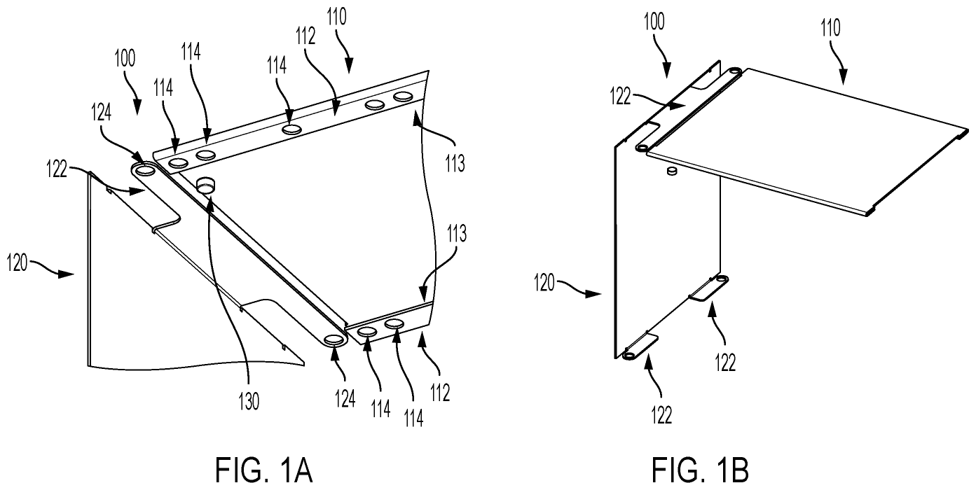

An unassembled magnetic shelf panel joint 100 is generally shown in FIGS. 1A and 1B. As shown in the embodiment in FIGS. 1A and 1B, each magnetic shelf panel joint 100 can include a vertical side shelf wall panel 120, a horizontal shelf panel 110, and a magnetic fastener 130. Vertical side shelf wall panel 120 may include one or more angled protrusions 122 defining one or more internal receptacles 124. Horizontal shelf panel 110 may include one or more groove bodies 112 defining one or more grooves 113 and external receptacles 114. In the embodiment shown in FIGS. 1A and 1B, angled protrusion 122 can be inserted into groove 113. After insertion, internal receptacle 124 can be aligned with external receptacle 114, and magnetic fastener 130 can be inserted into both internal receptacle 124 and external receptacle 114.

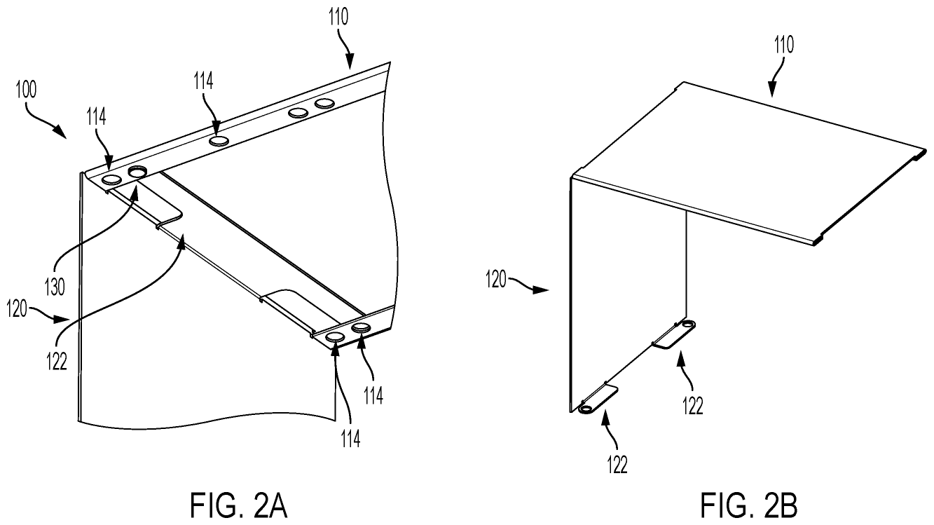

An assembled magnetic shelf panel joint 100 is generally shown in FIGS. 2A and 2B. As shown in the embodiment in FIGS. 2A and 2B, after angled protrusion 122 is inserted into groove 113 and internal receptacle 124 is aligned with external receptacle 114, magnetic fastener 130 is inserted into external receptacle 114 and internal receptacle 124. Magnetic fastener 130 magnetically secures vertical side shelf wall panel 120 and horizontal shelf panel 110. Magnetic shelf panel joint 100 may, among other things, be used to joint shelf panels of a variety of storage solutions.

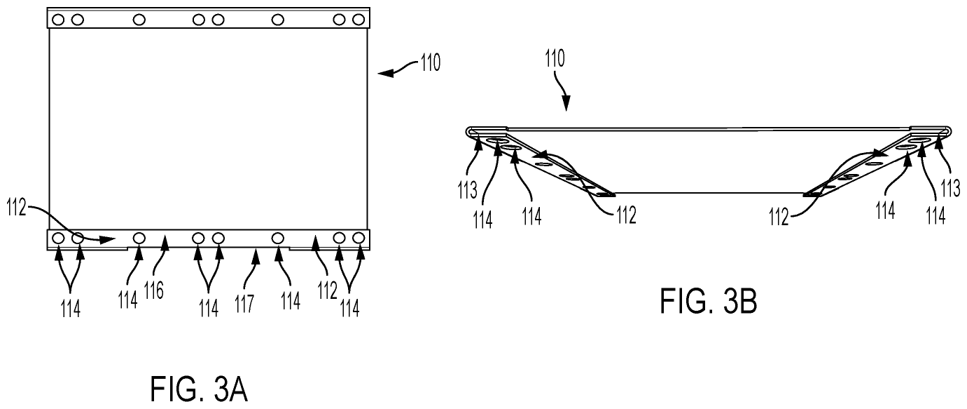

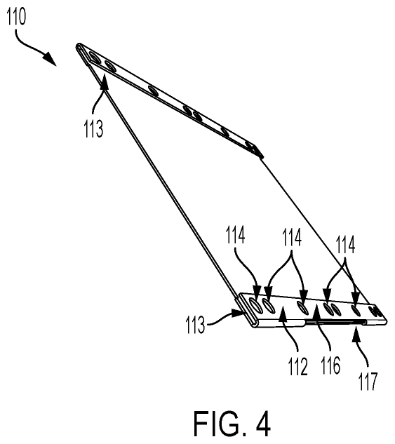

As shown in greater detail in FIGS. 3A, 3B, and 4, horizontal shelf panel 110 may include multiple groove bodies 112 defining multiple groves 113 and external receptacles 114. Each groove is capable of receiving multiple protrusions and each external receptacle is capable of receiving a magnetic fastener. Horizontal shelf panel 110 may also include one or more slot bodies 116 defining one or more slots 117 and external receptacles 114. Each slot is capable of receiving multiple protrusions and each external receptacle is capable of receiving a magnetic fastener. Horizontal shelf panel 110 may enable magnetic shelf panel joints 100 multiple sides, thereby securing multiple vertical side shelf wall panels 120. In some embodiments, horizontal shelf panel 110 may be comprised of steel or any other rigid, magnetic material.

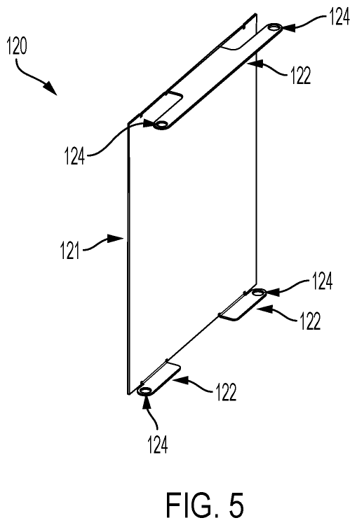

As shown in greater detail in FIG. 5, vertical side shelf wall 120 comprises multiple angled protrusions 122 on one side of a shelf wall 121. Accordingly, vertical side shelf wall 120 may be used on the exterior of a shelving unit. Vertical side shelf wall 120 may enable multiple magnetic shelf panel joints 100. For example, a horizontal shelf panel 110 could be connected to an upper protrusion and a lower protrusion. In some embodiments, vertical side shelf 120 can be comprised of steel, aluminum, polyvinyl chloride, polyethylene, other plastics, or other hard materials.

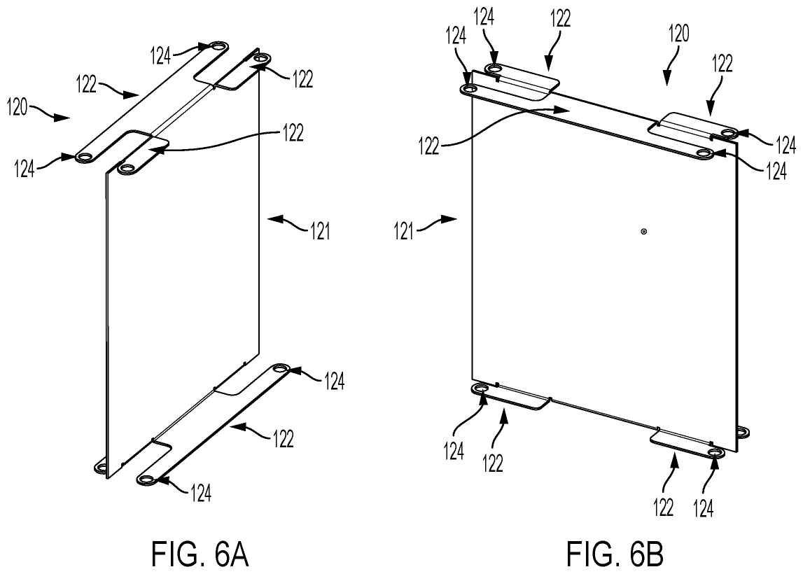

FIG. 6 illustrates an alternative embodiment of vertical side shelf wall panel 120 that comprises multiple protrusions on both sides of a shelf wall 121. Accordingly, vertical side shelf wall 120 may be used on the interior of a shelving unit. Vertical side shelf wall 120 may enable multiple magnetic shelf panel joints 100 on both sides of shelf wall 121. For example, a horizontal shelf panel 110 could be connected to upper and lower protrusions on both sides of shelf wall 121.

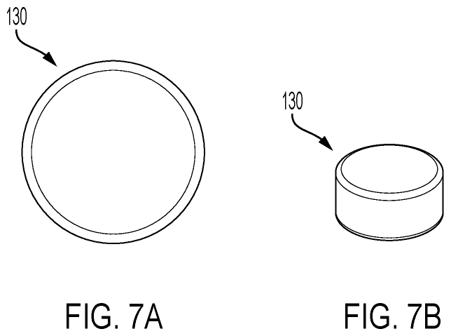

A magnetic fastener 130 is generally shown in FIGS. 7A and 7B. Magnetic fastener 130 is sized to fit inside internal receptacle 124 and external receptacle 114. In some embodiments, magnetic fastener 130 can be comprised of a neodymium magnet, a alnico magnet, a ceramic magnet, a samarium-cobalt magnet, or any other type of magnet. In alternative embodiments, the magnetic fastener may have additional textures, protrusions, or geometry to facilitate easy insertion and removal.

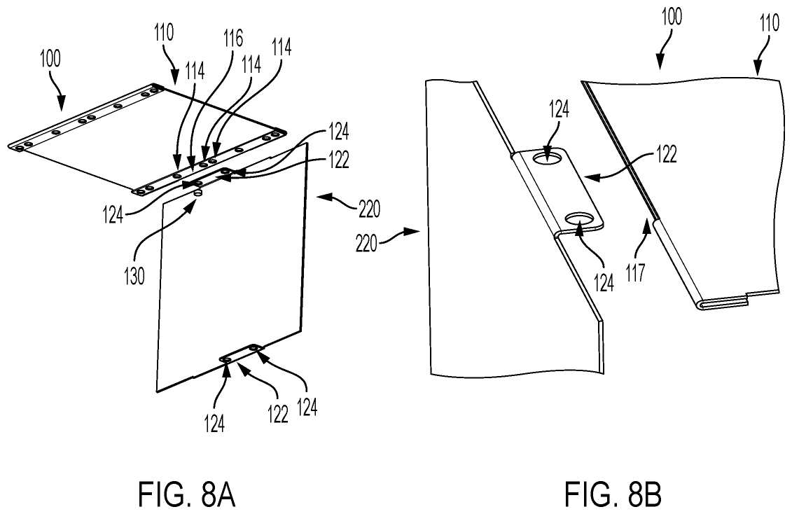

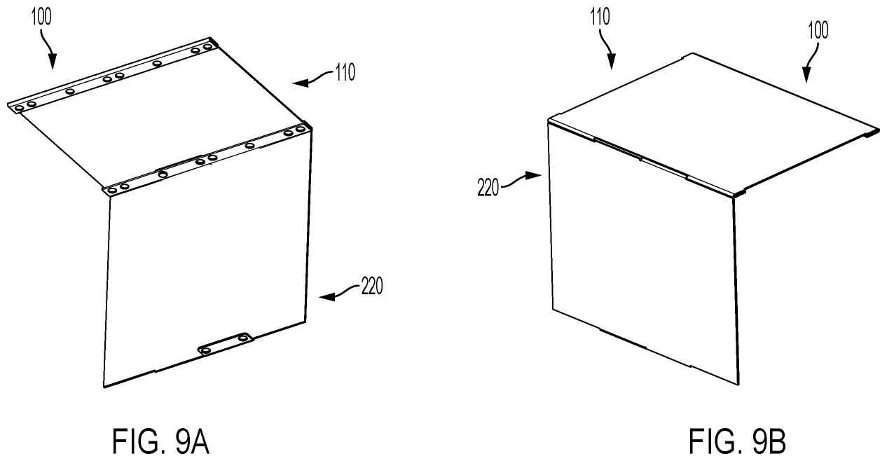

FIGS. 8A, 8B, 9A, and 9B illustrate an alternative embodiment of magnetic panel joint 100. As shown in the embodiment in FIGS. 8A and 8B, each magnetic shelf panel joint 100 can include a vertical rear shelf wall panel 220, a horizontal shelf panel 110, and a magnetic fastener 130. Vertical rear shelf wall panel 220 may include one or more angled protrusions 122 defining one or more internal receptacles 124. Horizontal shelf panel 110 may include one or more slot bodies 116 defining one or more slots 117 and external receptacles 114. In the embodiment shown in FIGS. 8A and 8B, angled protrusion 122 can be inserted into slot 117. After insertion, internal receptacle 124 can be aligned with external receptacle 114, and magnetic fastener 130 can be inserted into both internal receptacle 124 and external receptacle 114.

An assembled magnetic shelf panel joint 100 is generally shown in FIGS. 9A and 9B. As shown in the embodiment in FIGS. 9A and 9B, after angled protrusion 122 is inserted into slot 117 and internal receptacle 124 is aligned with external receptacle 114, magnetic fastener 130 is inserted into external receptacle 114 and internal receptacle 124. Magnetic fastener 130 magnetically secures vertical rear shelf wall panel 220 and horizontal shelf panel 110. Magnetic shelf panel joint 100 may, among other things, be used to joint shelf panels of a variety of storage solutions. Vertical rear shelf wall panel 220 may provide stability to shelving units.

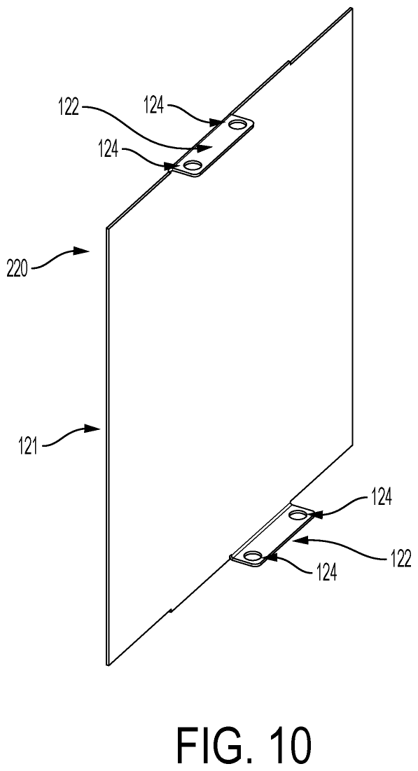

As shown in greater detail in FIG. 10, vertical rear shelf wall 220 comprises multiple angled protrusions 122 on one side of a shelf wall 121. Accordingly, vertical rear shelf wall 220 may be used on the exterior of a shelving unit or other storage solution. In some embodiments, vertical side shelf 120 can be comprised of steel, aluminum, polyvinyl chloride, polyethylene, other plastics, or other hard materials.

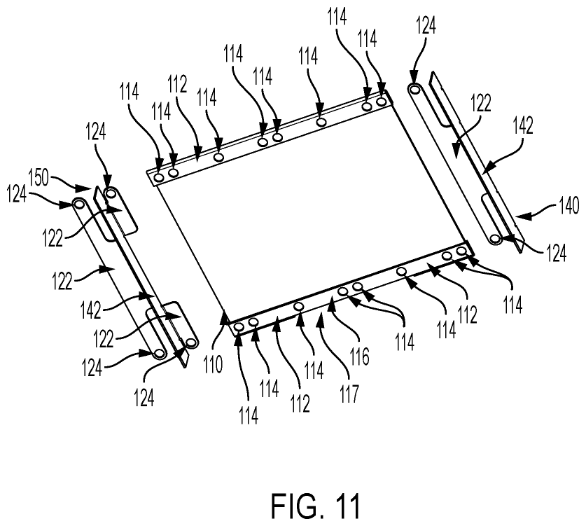

FIG. 11 illustrates a horizontal shelf 110 prior to assembly with a foot component 140 and a tee component 150. Foot component 140 includes an angled protrusion 122 defining one or more internal receptacles 124 and a foot 142. Tee component 150 includes one or more angled protrusions on both sides of a foot 142. In the embodiment shown in FIG. 11, angled protrusions 122 can be inserted into grooves 113. After insertion, internal receptacles 124 can be aligned with external receptacles 114, and magnetic fasteners 130 can be inserted into both internal receptacle 124 and external receptacle 114. Feet 142 may point downward and contact a flooring surface and serve as the foundation of a shelving unit or storage solution. Alternatively, feet may point upward at the top of a shelving unit or storage solution and serve as dividers or outer barriers to enable storage on top of a shelving unit or storage solution.

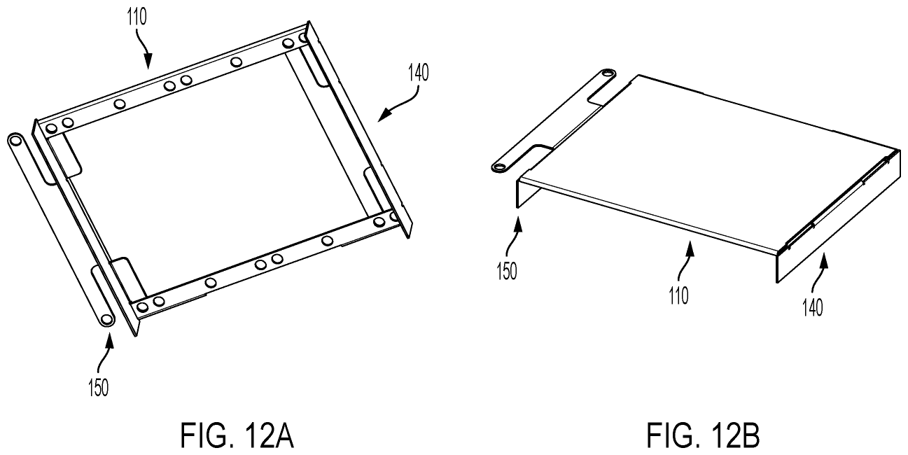

FIGS. 12A and 12B illustrate a horizontal shelf 110 assembled with a foot component 140 and a tee component 150. As shown in the embodiment in FIGS. 12A and 12B, after angled protrusion 122 is inserted into groove 113 and internal receptacle 124 is aligned with external receptacle 114, magnetic fasteners 130 are inserted into external receptacle 114 and internal receptacle 124.

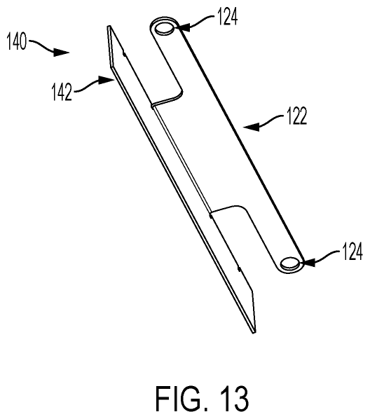

As shown in greater detail in FIG. 13, a foot component 140 can include an angled protrusion 122 defining one or more internal receptacles 124 and a foot 142. Accordingly, foot component 140 may be used on the exterior of a shelving unit or storage solution.

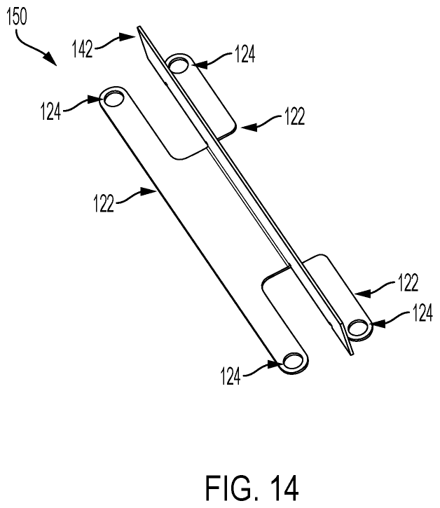

As shown in greater detail in FIG. 14, a tee component 150 comprises multiple protrusions on both sides of a foot 142. Accordingly, tee component 150 may be used on the interior of a shelving unit. Tee component 150 may enable multiple magnetic shelf panel joints 100 on both sides of foot 142. For example, a horizontal shelf panel 110 could be connected to protrusions on both sides of foot 142.

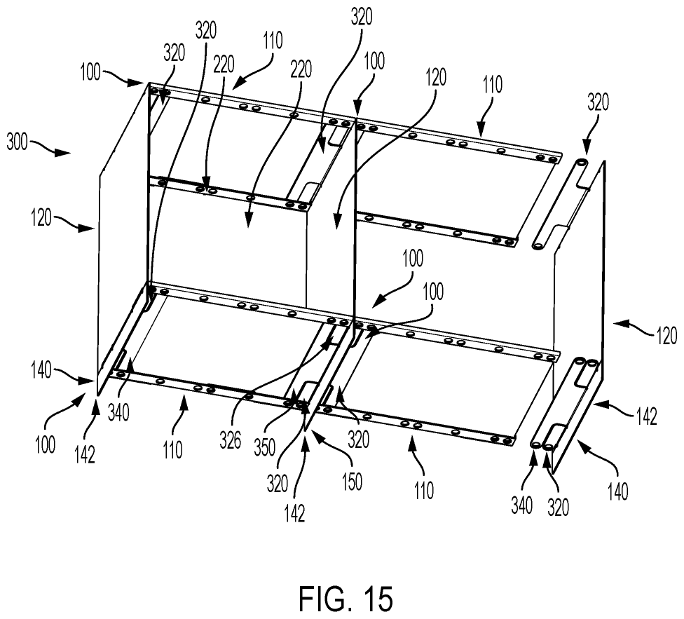

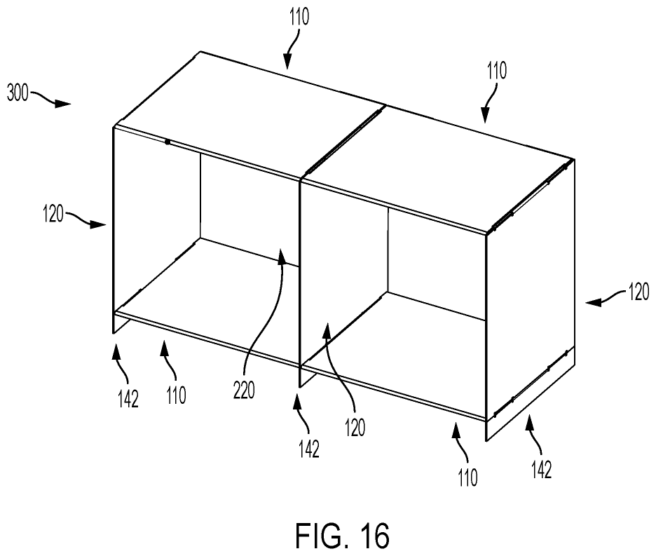

A storage apparatus 300 comprising multiple magnetic panel joints 100 is generally shown in FIGS. 15 and 16. As shown in the embodiment in FIGS. 15 and 16, four horizontal shelf panels 110 are joined to three vertical side shelf wall panels 120. Multiple protrusions may be inserted into each groove to create an infinite number of storage apparatus configurations. For example, vertical side shelf wall panel protrusions 320 may be stacked with foot component protrusions 340 and inserted into the same groove of horizontal shelf panel 110. Also, vertical side shelf wall panel protrusions 320 may be stacked with tee component protrusions 350 and inserted into the same groove of horizontal shelf panel 110. Certain features of magnetic panel joints 100 of storage apparatus 300 are not discussed in these examples where such features may be similar to those discussed for other embodiments.

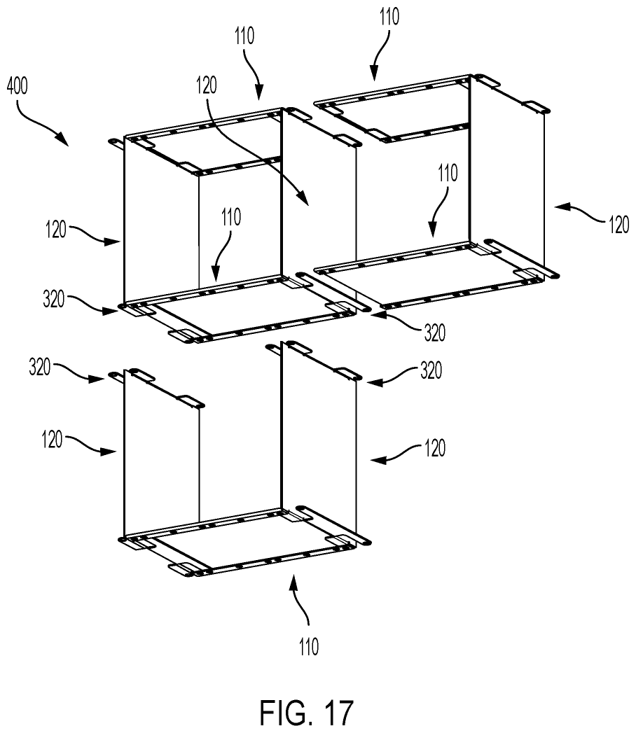

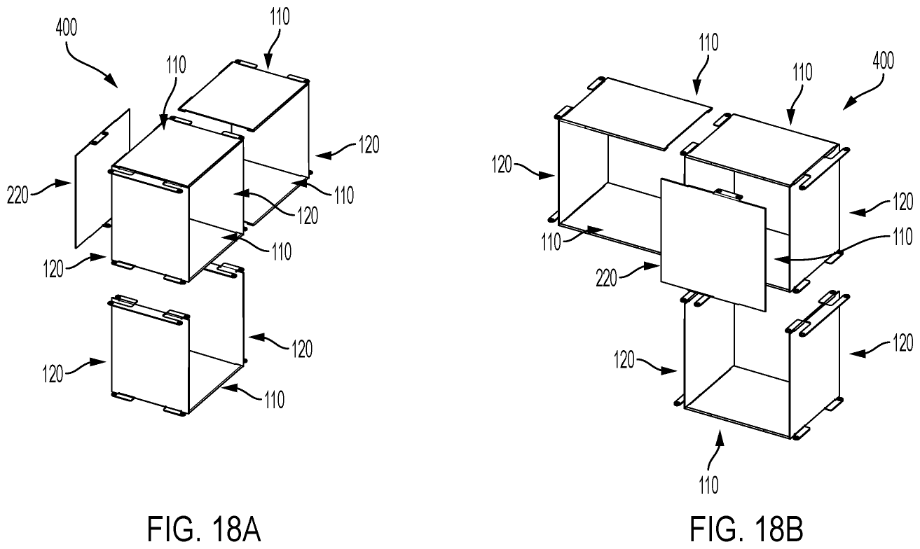

An unassembled storage apparatus 400 comprising multiple magnetic panel joints 100 is generally shown in FIGS. 17, 18A and 18B. As shown in the embodiment in FIGS. 17, 18A, and 18B, five horizontal shelf panels 110 are joined to five vertical side shelf wall panels 120. Multiple protrusions may be inserted into each groove to create an infinite number of storage apparatus configurations. For example, vertical side shelf wall panel protrusions 320 may be stacked with other vertical side shelf wall panel protrusions 320 and inserted into the same groove of horizontal shelf panel 110. Additionally, vertical rear shelf wall panels may be joined to horizontal shelf panels 110 simultaneously. Certain features of magnetic panel joints 100 of storage apparatus 400 are not discussed in these examples where such features may be similar to those discussed for other embodiments.

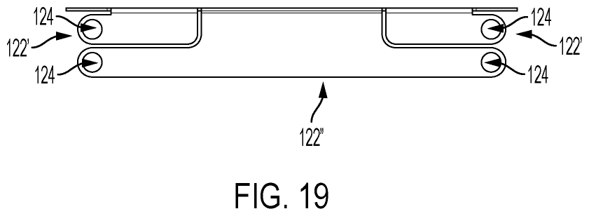

As shown in greater detail in FIG. 19, protrusions of one storage apparatus component 122′ can be stacked on protrusions of another storage apparatus component 122″. Stacked protrusions may be inserted into a groove 112 or slot 117 of a horizontal shelf panel 110.

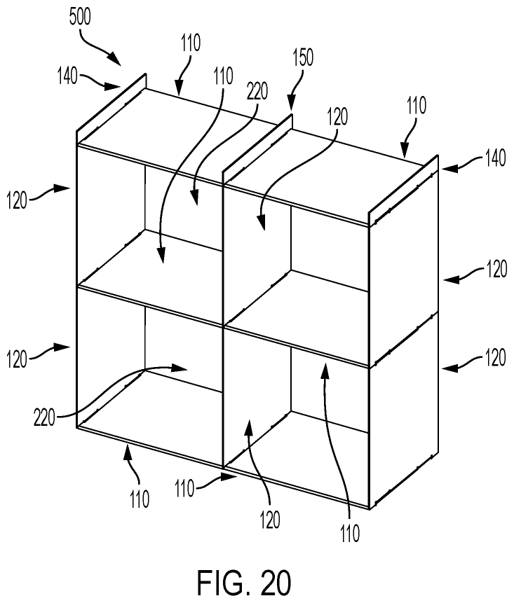

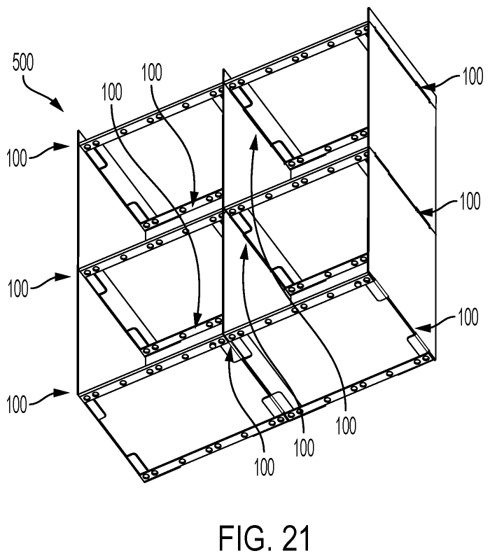

An assembled storage apparatus 500 comprising multiple magnetic panel joints 100 is generally shown in FIGS. 20 and 21. As shown in the embodiment in FIGS. 20 and 21 six horizontal shelf panels 110 are joined to six vertical side shelf wall panels 120, two foot components 140, and one tee component 150. Additionally, vertical rear shelf wall panels may be joined to horizontal shelf panels 110 simultaneously. Certain features of magnetic panel joints 100 of storage apparatus 500 are not discussed in these examples where such features may be similar to those discussed for other embodiments.

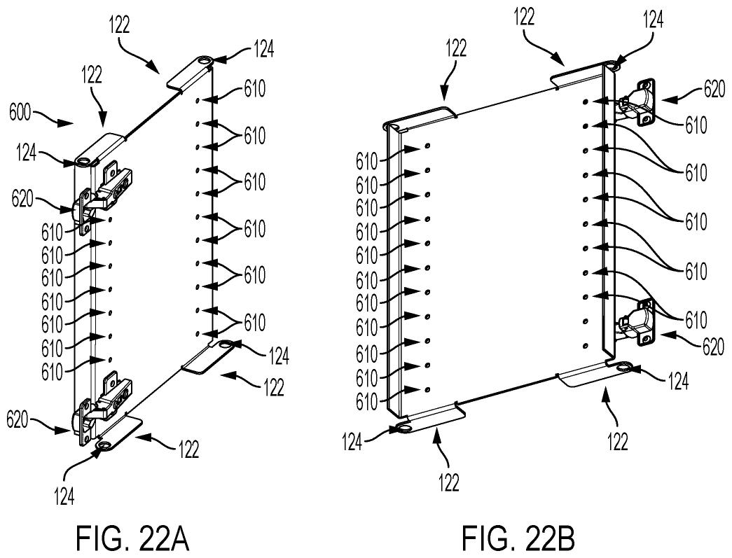

FIGS. 22A and 22B illustrate a double panel 600 with multiple cabinet hardware fastener receptacles 610 and cabinet hardware components 620. Cabinet hardware fastener receptacles allow cabinet hardware components 620 such as hinges to mount to double panels via fasteners such as bolts and screws. Double panel 600 has angled protrusions 122 defining internal receptacles 124 to enable compatibility with magnetic panel joints 100. For example, Double panel 600 could be installed on storage apparatus 300, 400, or 500. Certain features of magnetic panel joints 100 are not discussed in these examples where such features may be similar to those discussed for other embodiments.

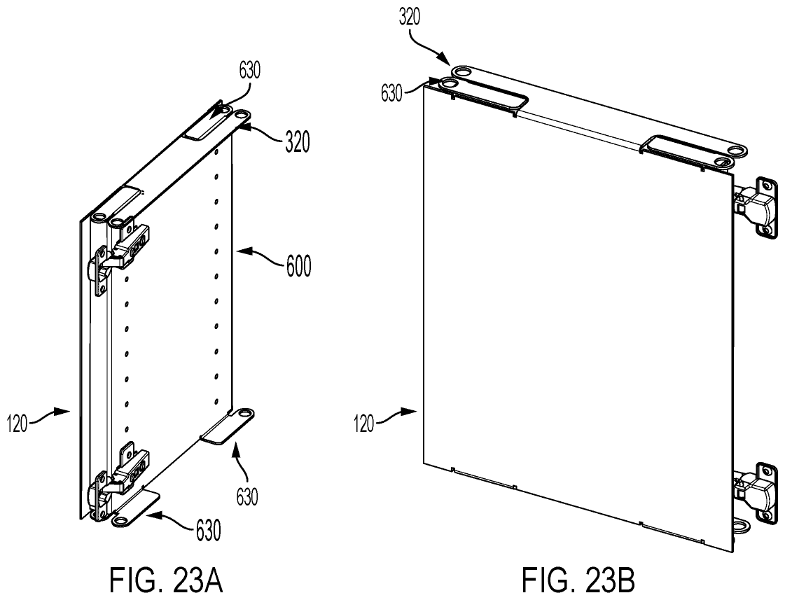

A double panel 600 assembled with a vertical side shelf wall panel 120 is generally shown in FIGS. 23A and 23B. As shown in the embodiment in FIGS. 23A and 23B, double panel protrusions 630 can be stacked with vertical side shelf wall panel protrusions 320 and inserted into the same groove 113 or slot 116 of horizontal shelf panel 110.

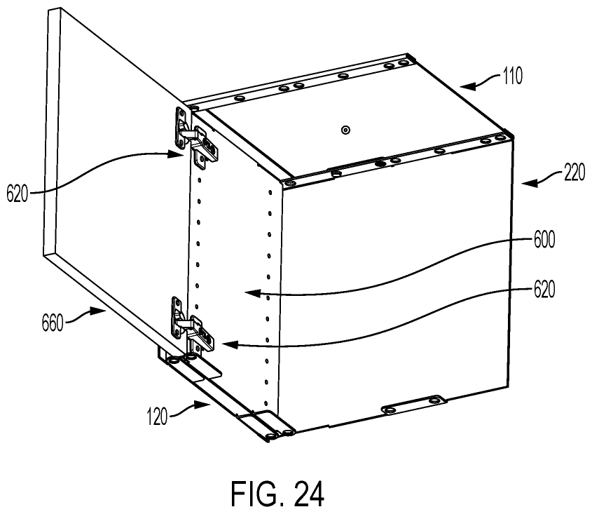

FIG. 24 illustrates a double panel 600 assembled with a vertical side shelf wall panel 120, a horizontal shelf panel 110, and a vertical rear shelf wall panel 220. Cabinet hardware 620 may be mounted to cabinet hardware fastener receptacles 610. Cabinet hardware 620 may also be coupled to a cabinet door 660.

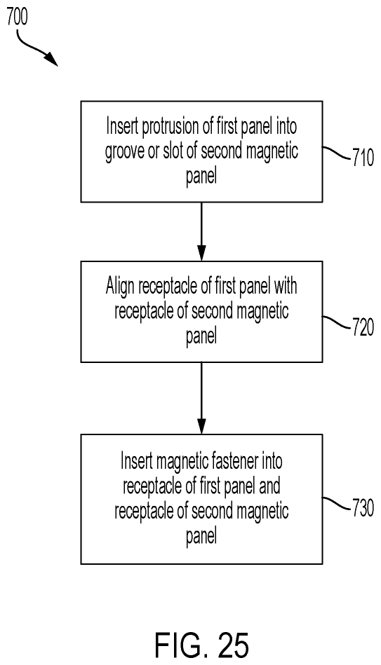

FIG. 25 shows diagrammatically method for securing magnetic panels 700 of one embodiment of magnetic shelf panel joint, as also described herein. Method 700 begins with insertion step 710 by inserting the protrusion 122 of a first panel into the groove 113 or slot 117 of a second magnetic panel. After insertion step 710, alignment step 720 occurs wherein an internal receptacle 124 of the first panel is aligned with an external receptacle 114 of the second magnetic panel. After insertion step 720, fastening step 730 occurs in which magnetic fastener 130 is inserted into the external receptacle 114 of the second magnetic panel and the internal receptacle 124 of the first magnetic panel.

In the foregoing specification, embodiments have been described with reference to numerous specific details that can vary from implementation to implementation. Certain adaptations and modifications of the described embodiments can be made. It is also intended that the sequence of steps shown in the figures are only for illustrative purposes and are not intended to be limited to any particular sequence of steps. As such, those skilled in the art can appreciate that these steps can be performed in a different order while implementing the same method.

In the drawings and specification there have been disclosed exemplary embodiments. it will be apparent to those skilled in the art that various modifications and variations can be made to the disclosed apparatuses, systems, and related methods. Other embodiments will be apparent to those skilled in the art from consideration of the specification and practice of the disclosed apparatuses, systems, and related methods. It is intended that the specification and examples be considered as exemplary only, with a true scope being indicated by the following claims and their equivalents.

What is claimed is:

1. A magnetic panel joint comprising:
a first panel including an angled protrusion defining a first receptacle;
a second magnetic panel including a groove body defining a groove and a second receptacle; and
a magnetic fastener; wherein the angled protrusion is configured to removably engage in the groove to enable alignment of the first receptacle and the second receptacle and the magnet fastener is configured to removably engage in the first receptacle and the second receptacle to couple the first panel and the second magnetic panel.

2. The magnetic panel joint of claim 1, wherein the first panel is a vertical wall

3. The magnetic panel joint of claim 1, wherein the second magnetic panel is a horizontal shelf.

4. A magnetic panel joint comprising:
a first panel including an angled protrusion defining a first receptacle;
a second magnetic panel including a slot body defining a slot and a second receptacle; and
a magnetic fastener; wherein the angled protrusion is configured to removably engage in the slot to enable alignment of the first receptacle and the second receptacle and the magnetic fastener is configured to removably engage in the first receptacle and the second receptacle to couple the first panel and the second magnetic panel.

5. The magnetic panel joint of claim 4, wherein the first panel is a rear wall.

6. The magnetic panel joint of claim 4, wherein the second magnetic panel is a horizontal shelf.

7. A storage apparatus comprising:
a first magnetic panel including a groove body and a slot body, the groove body defining a groove and a first external receptacle, the slot body defining a slot and a second external receptacle;
a second panel including a first angled protrusion defining a first internal receptacle;
a third panel including a second angled protrusion defining a second internal receptacle;
a first magnetic fastener; and
a second magnetic fastener; wherein the first angled protrusion is configured to removably engage in the groove to enable alignment of the first internal receptacle and the first external receptacle and the first magnet fastener is configured to removably engage in the first internal receptacle and the first external receptacle to enable secure coupling of the first magnetic panel and the second panel; and
wherein the second angled protrusion is configured to removably engage in the slot to enable alignment of the second internal receptacle and the second external receptacle and the second magnet fastener is configured to removably engage in the second internal receptacle and the second external receptacle to couple the first magnetic panel and the third panel.

8. The storage apparatus of claim 7, wherein the first magnetic panel is a horizontal shelf.

9. The storage apparatus of claim 7, wherein the second panel is a vertical wall.

10. The storage apparatus of claim 7, wherein the third panel is a rear wall.

11. The storage apparatus of claim 7 further comprising a tee component, wherein the tee component comprises a first protrusion, a second protrusion, and a foot component.

12. The storage apparatus of claim 7 further comprising a foot component, wherein the foot component comprises a protrusion and a foot.

13. The storage apparatus of claim 7 further comprising:
a fourth panel including a third angled protrusion defining a third internal receptacle; and
a third magnetic fastener; wherein the groove further comprises a third external receptacle and the third angled protrusion can be removably engaged in the groove to enable alignment of the third internal receptacle and the third external receptacle; and
wherein the third magnetic fastener can be removably engaged in the third internal receptacle and the third external receptacle to enable coupling of the first magnetic panel and the fourth panel.

14. The storage apparatus of claim 13, wherein the fourth panel is a vertical wall.

15. The storage apparatus of claim 13, wherein the second panel is a vertical wall and the fourth panel is a vertical wall.

16. The storage apparatus of claim 7, wherein the second panel further comprises a third protrusion defining a third internal receptacle.

17. The storage apparatus of claim 16 further comprising a fourth magnetic panel and a third magnetic fastener, wherein the fourth magnetic panel comprises a second groove body defining a second groove and a third external receptacle; and
wherein the third protrusion can be removably engaged in the second groove to enable alignment of the third internal receptacle and the third external receptacle; and
wherein the third magnetic fastener can be removably engaged in the third internal receptacle and the third external receptacle to enable secure coupling of the second panel and the fourth magnetic panel.

18. The storage apparatus of claim 17, wherein the fourth magnetic panel is a horizontal shelf.

19. A storage apparatus comprising:
a first magnetic panel including a first groove body defining a first groove and a first external receptacle;
a second panel including a first angled protrusion defining a first internal receptacle and a second angled protrusion defining a second internal receptacle;
a third magnetic panel including a second groove body defining a second groove and a second external receptacle;
a first magnetic fastener; and
a second magnetic fastener; wherein the first angled protrusion is configured to removably engage in the first groove to enable alignment of the first internal receptacle and the first external receptacle and the first magnet fastener is configured to removably engage in the first internal receptacle and the first external receptacle to enable secure coupling of the first magnetic panel and the second panel; and
wherein the second angled protrusion is configured to removably engage in the slot to enable alignment of the second internal receptacle and the second external receptacle and the second magnet fastener is configured to removably engage in the second internal receptacle and the second external receptacle to couple the second panel and the third magnetic panel.

20. The storage apparatus of claim 19, wherein the first magnetic panel is a horizontal shelf.

21. The storage apparatus of claim 19, wherein the second panel is a vertical wall.

22. The storage apparatus of claim 19, wherein the first magnetic panel is a horizontal shelf, the second panel is a vertical wall, and the third magnetic panel is a horizontal shelf.

23. A storage apparatus comprising:
a first magnetic panel including a groove body defining a groove, a first external receptacle, and a second external receptacle;
a second panel including a first angled protrusion defining a first internal receptacle;
a third panel including a second angled protrusion defining a second internal receptacle;
a first magnetic fastener; and
a second magnetic fastener; wherein the first angled protrusion is configured to removably engage in the groove to enable alignment of the first internal receptacle and the first external receptacle and the first magnet fastener is configured to removably engage in the first internal receptacle and the first external receptacle to enable secure coupling of the first magnetic panel and the second panel; and
wherein the second angled protrusion is configured to removably engage in the groove to enable alignment of the second internal receptacle and the second external receptacle and the second magnet fastener is configured to removably engage in the second internal receptacle and the second external receptacle to couple the first magnetic panel and the third panel.

24. The storage apparatus of claim 23, wherein the first magnetic panel is a horizontal shelf, the second panel is a vertical wall, and the third panel is a vertical wall.

25. A storage apparatus comprising:
a first magnetic panel including a groove body, the groove body defining a groove and a first external receptacle;
a second panel including a first angled protrusion defining a first internal receptacle;
a first magnetic fastener, wherein the first angled protrusion is configured to removably engage in the groove to enable alignment of the first internal receptacle and the first external receptacle and the first magnet fastener is configured to removably engage in the first internal receptacle and the first external receptacle to enable secure coupling of the first magnetic panel and the second panel.

26. The storage apparatus of claim 25 further comprising a third panel defining a cabinet hardware fastener receptacle, a cabinet hardware component, a cabinet hardware fastener and a second angled protrusion defining a second internal receptacle; wherein the second angled protrusion is configured to removably engage in the slot to enable alignment of the second internal receptacle and the second external receptacle and the second magnet fastener is configured to removably engage in the second internal receptacle and the second external receptacle to couple the first magnetic panel and the third panel; and
wherein the cabinet hardware fastener is configured to removably engage in the cabinet hardware component and the cabinet hardware fastener receptacle to couple the cabinet hardware component and the third panel.

27. A storage apparatus comprising:
a first magnetic panel including a slot body, the slot body defining a slot and a second external receptacle;
a second panel including a first angled protrusion defining a first internal receptacle;
a first magnetic fastener, wherein the first angled protrusion is configured to removably engage in the slot to enable alignment of the first internal receptacle and the first external receptacle and the first magnet fastener is configured to removably engage in the first internal receptacle and the first external receptacle to enable secure coupling of the first magnetic panel and the second panel.

28. A method for joining magnetic panels including:
inserting a protrusion of a first panel into a groove of a second magnetic panel;
aligning a receptacle of the first panel with a receptacle of the second magnetic panel;
inserting a magnetic fastener into the receptacle of the first panel and the receptacle of the second magnetic panel.

29. A method for joining magnetic panels including:
inserting a protrusion of a first panel into a slot of a second magnetic panel;
aligning a receptacle of the first panel with a receptacle of the second magnetic panel;
inserting a magnetic fastener into the receptacle of the first panel and the receptacle of the second magnetic panel.
